(19) United States
(12) Patent Application Publication
(10) Pub. No.: US 2009/0132264 A1
(43) Pub. Date: May 21, 2009

(54) MEDIA ASSET EVALUATION BASED ON SOCIAL RELATIONSHIPS

(76) Inventors: Mark D. Wood, Penfield, NY (US); John R. Birkelund, Fairport, NY (US)

Correspondence Address: David A. Novais;Patent Legal Staff, Eastman Kodak Company, 343 State Street, Rochester, NY, 14650-2201, US

(21) Appl. No.: 11/941,146

(22) Filed: Nov. 16, 2007

(51) Int. Cl. G06Q 10/00

(52) U.S. Cl. 705/1

(57) ABSTRACT

A method for evaluating media assets in a set of media assets including the step of obtaining information defining at least social relationships of an audience. The social relationships include relationships between a member of the audience and someone recorded in at least one of the media assets. For each media asset in the set of media assets, the method includes identifying one or more people recorded in the digital media asset, computing, for each person recorded in the digital media asset, the person's expected social significance relative to the audience based at least upon the social relationships, and computing an overall measurement of the social significance of the digital media asset as a function of the expected social significance of each person recorded in the asset. In addition, the method includes storing the overall measurement for each digital media asset in a processor-accessible memory system.

### FIELD OF THE INVENTION

This invention relates to evaluating media assets, such as digital still images or video. Embodiments of this invention pertain to evaluating media assets based at least upon social relationships between a member of an audience viewing the assets and people recorded in the media assets.

### BACKGROUND

Digital recording has vastly increased the ability of consumers to amass very large numbers of still images, video image sequences, and multimedia records combining one or more images and other content. (Still images, audio recordings, video sequences, and multimedia records are referred to collectively herein with the term “media assets.”) With very large numbers of media assets, organization becomes difficult.

Efforts have been made to aid users in organizing and utilizing media assets by assigning metadata to individual media assets that indicates a metric of expected value to the user. For example, the V-550 digital camera, marketed by Eastman Kodak Company of Rochester, N.Y., includes a user control labeled “Share,” which can be actuated by the user to designate a respective image for preferential printing and e-mailing. This approach is useful, but is limited by the metric being binary.

U.S. Patent Publication No. 2003/0128389 A1, filed by Matraszek et al., discloses another measure of media asset importance, “affective information,” which can take the form of a multi-valued metadata tag. The affective information can be a manual entry or can automatically detect user reactions, including user initiated utilization of a particular image, such as how many times an image was printed or sent to others via e-mail. In either case, affective information is identified with a particular user. This approach is useful, but complex if user reactions are automatically detected. There is also the risk of user reactions being ambiguous. Moreover, this approach requires past interactions between the user and a particular asset in order to compute this importance measure.

U.S. Pat. No. 6,671,405 to Savakis et al., discloses another approach, which computes a metric of “emphasis and appeal” of an image, without user intervention. A first metric is based upon a number of factors, which can include: image semantic content (e.g. people, faces); objective features, such as colorfulness and sharpness; and main subject features, such as size of the main subject. A second metric compares the factors relative to other images in a collection. The factors are integrated using a trained reasoning engine. U.S. Patent Publication No. 2004/0075743 (Chatani et al.) is somewhat similar and discloses image sorting of images based upon user-selected parameters of semantic content or objective features in the images. These approaches have the advantage of working from the images themselves and the shortcoming of being computationally intensive.

U.S. Patent Application Publication No. 2005/0198044 (Kato et al.) discloses the problem of dynamically computing the value of certain information based upon context. The solution it teaches concerns the specific problem of associating a value to topics, where the value is dynamically adjusted based upon communication and usage.

None of these approaches provide a means for computing or using a metric for the expected value of any type of content, including a media asset, to a particular audience based upon an analysis of the social relationships between the audience and the people represented or portrayed in the content.

It would thus be desirable to provide an easily computed metric for assessing the expected value of a media asset to a given audience based upon an analysis of the social relationships between the audience and the people portrayed in the media asset.

### SUMMARY

The above-described problems are addressed and a technical solution is achieved in the art by a system and a method for evaluating media assets in a set of media assets, according to various embodiments of the present invention.

In an embodiment of the present invention, information defining at least social relationships of an audience is obtained. The social relationships include relationships between a member of the audience and someone recorded in at least one of the media assets. For each media asset in the set of media assets, according to an embodiment, (1) one or more people recorded in the digital media asset is/are identified, (2) for each person recorded in the digital media asset, a measure of the person's expected social significance relative to the audience is computed based at least upon the social relationships, and (3) an overall measurement of the social significance of the digital media asset is computed as a function of the expected social significance of each person recorded in the asset. The overall measurement for each digital media asset may be stored in a processor-accessible memory system. The overall measurements may be used to facilitate the identification of digital media assets of interest to the audience.

In addition to the embodiments described above, further embodiments will become apparent by reference to the drawings and by study of the following detailed description.

### BRIEF DESCRIPTION OF THE DRAWINGS

The present invention will be more readily understood from the detailed description of exemplary embodiments presented below considered in conjunction with the attached drawings, of which:

FIG. 1 illustrates a system for evaluating media assets in a set of media assets, according to an embodiment of the present invention;

FIG. 2 illustrates the steps in computing the social image value index, according to an embodiment of the present invention;

FIG. 3 illustrates an exploded view of step 208 as illustrated in the method of FIG. 2, according to an embodiment of the present invention;

FIG. 4 and FIG. 5 illustrate a method for computing the social relevance score of one person relative to another, according to an embodiment of the present invention;

FIG. 6 illustrates a scenario where digital image asset records portray three people and is being viewed by an audience of one person, according to an embodiment of the present invention;

FIG. 7 illustrates a scenario where digital image asset records portray three people and is being viewed by an audience of two people, according to an embodiment of the present invention;

FIG. 8 illustrates a user interface whereby the social relationships for a given person may be entered, according to an embodiment of the present invention;

FIG. 9 illustrates an embodiment for determining whether or not two people are related by family ties, according to an embodiment of the present invention; and

FIG. 10 illustrates a set of simple social relationships between a set of people, according to an embodiment of the present invention.

It is to be understood that the attached drawings are for purposes of illustrating the concepts of the invention and may not be to scale.

### DETAILED DESCRIPTION

Digital cameras and camera cell phones have made it possible for consumers to capture and save vast numbers of media assets. The sheer number of media assets can be overwhelming, making it very difficult for consumers to find appropriate assets to share with their friends and family. Embodiments of the present invention provide ways to efficiently compute a metric, referred to herein as the social image value index, or the overall measurement of expected social significance, which provides a measure of the expected interest of a particular media asset to a particular audience. With knowledge of this metric, a media asset retrieval and display system can automatically filter out inappropriate assets, and enable the consumer to quickly find and share those assets likely to be of the greatest interest to a particular audience.

The phrase, “media asset,” as used herein, refers to any media asset, such as a digital still image, a digital audio file, a digital video file, etc. Further, it should be noted that, unless otherwise explicitly noted or required by context, the word “or” is used in this disclosure in a non-exclusive sense.

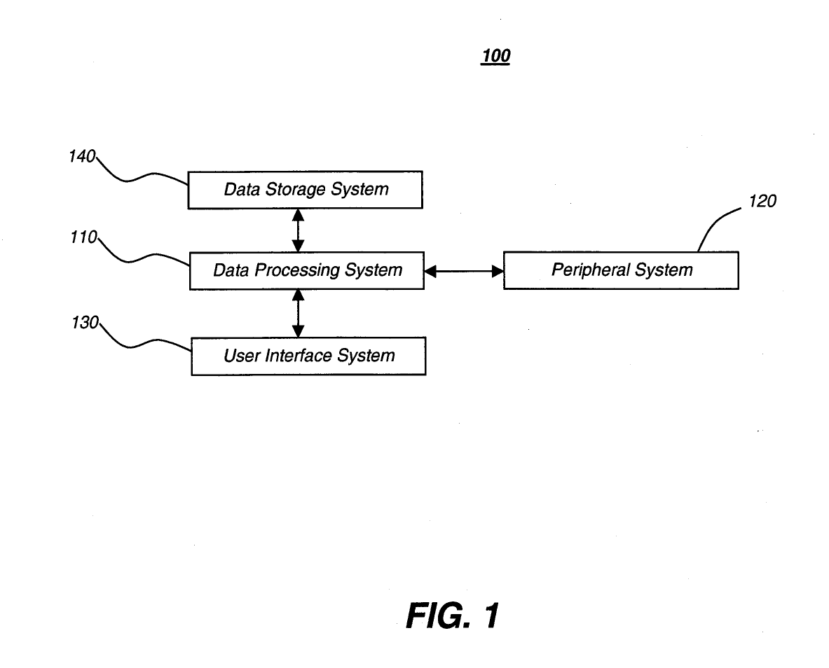

FIG. 1 illustrates a system 100 evaluating media assets in a set of media assets, according to an embodiment of the present invention. The system 100 includes a data processing system 110, a peripheral system 120, a user interface system 130, and a processor-accessible memory system 140. The processor-accessible memory system 140, the peripheral system 120, and the user interface system 130 are communicatively connected to the data processing system 110.

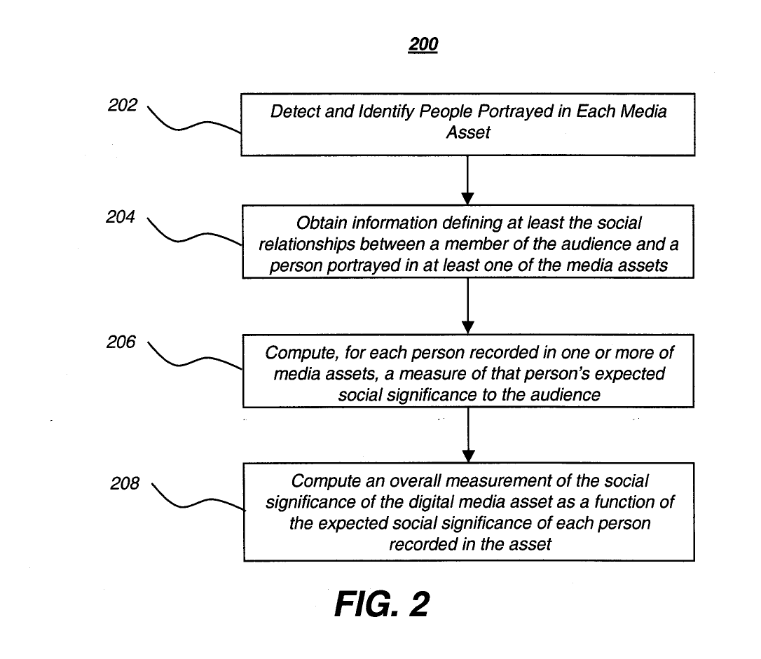

The data processing system 110 includes one or more data processing devices that implement the processes of the various embodiments of the present invention, including the example processes of FIGS. 2 through 7 and FIG. 9 described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

The processor-accessible memory system 140 includes one or more processor-accessible memories configured to store information, including the information needed to execute the processes of the various embodiments of the present invention, including the example processes of FIGS. 2 through 7 and FIG. 9 described herein. The processor-accessible memory system 140 may be a distributed processor-accessible memory system including multiple processor-accessible memories communicatively connected to the data processing system 110 via a plurality of computers and/or devices. On the other hand, the processor-accessible memory system 140 need not be a distributed processor-accessible memory system and, consequently, may include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, floppy disks, hard disks, Compact Discs, DVDs, flash memories, ROMs, and RAMs.

The phrase “communicatively connected” is intended to include any type of connection, whether wired or wireless, between devices, data processors, or programs in which data may be communicated. Further, the phrase “communicatively connected” is intended to include a connection between devices or programs within a single data processor, a connection between devices or programs located in different data processors, and a connection between devices not located in data processors at all. In this regard, although the processor-accessible memory system 140 is shown separately from the data processing system 110, one skilled in the art will appreciate that the processor-accessible memory system 140 may be stored completely or partially within the data processing system 110. Further in this regard, although the peripheral system 120 and the user interface system 130 are shown separately from the data processing system 110, one skilled in the art will appreciate that one or both of such systems may be stored completely or partially within the data processing system 110.

The peripheral system 120 may include one or more devices configured to provide media assets to the data processing system 110. For example, the peripheral system 120 may include digital video cameras, cellular phones, regular digital cameras, scanners, audio recorders or other data processors. The data processing system 110, upon receipt of media assets from a device in the peripheral system 120, may store such media assets in the processor-accessible memory system 140.

The user interface system 130 may include a mouse, a keyboard, another computer, or any device or combination of devices from which data is input to the data processing system 110. In this regard, although the peripheral system 120 is shown separately from the user interface system 130, the peripheral system 120 may be included as part of the user interface system 130.

The user interface system 130 also may include a display device, a processor-accessible memory, or any device or combination of devices to which data is output by the data processing system 110. In this regard, if the user interface system 130 includes a processor-accessible memory, such memory may be part of the processor-accessible memory system 140 even though the user interface system 130 and the processor-accessible memory system 140 are shown separately in FIG. 1.

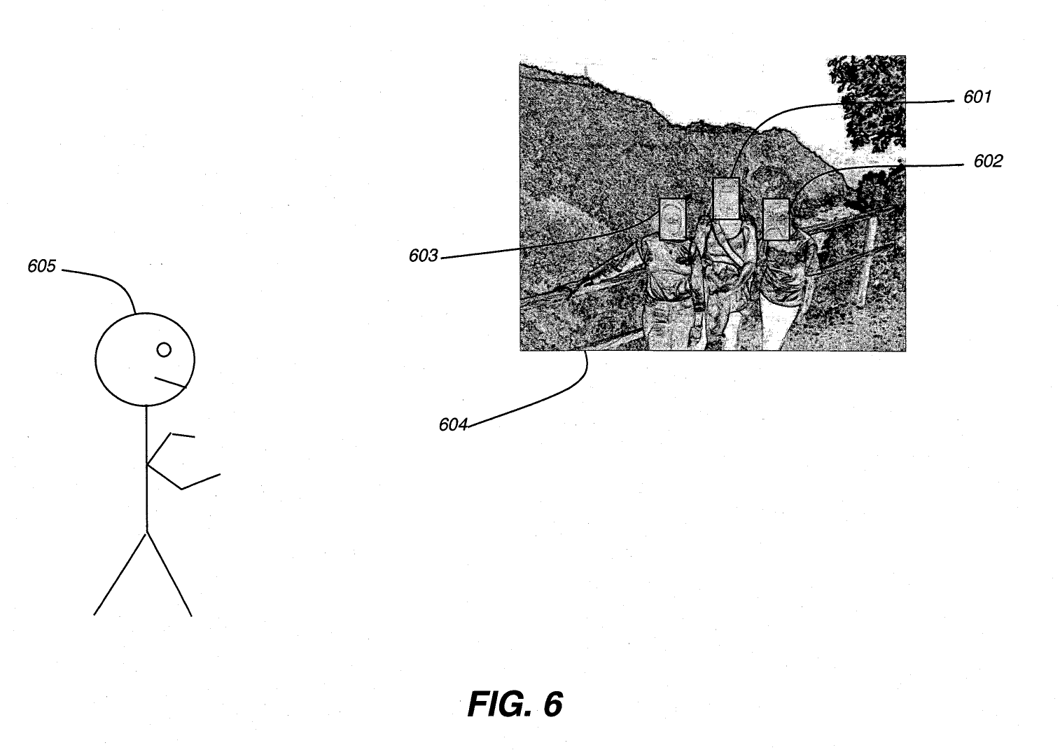

FIG. 2 illustrates a method 200 for computing an overall measure of the expected social significance of a digital media asset—the social image value index—according to an embodiment of the present invention. According to this embodiment of the method, the first step 202 executed by the data processing system 110 is to detect and identify the people portrayed in the digital media asset. FIG. 6 illustrates a picture 604 being displayed and viewed by an audience containing one person 605. As a result of step 202, the system 100 generates metadata associated with digital media asset 604 identifying the people portrayed by the asset: people 601, 602 and 603.

Step 202 is independent of the audience and in a preferred embodiment is performed in advance of the asset being used or viewed. One technique for recognizing people in images is to use face recognition. Face recognition is the identification or classification of a face to an example of a person or a label associated with a person based on facial features as described, for example, in U.S. patent application Ser. No. 11/559,544 entitled “User interface for face recognition” filed Nov. 14, 2006; U.S. patent application Ser. No. 11/342,053 entitled “Finding Images with Multiple People or Objects” filed Jan. 27, 2006; and U.S. Patent Publication No. 2007/0098303 entitled “Determining a Particular Person from a Collection” filed Oct. 31, 2005. In addition to automated techniques for people recognition, step 202 may be accomplished in whole or in part via manual techniques, wherein one or more users of the system 100 explicitly label each asset with the identities of the people recorded within the asset.

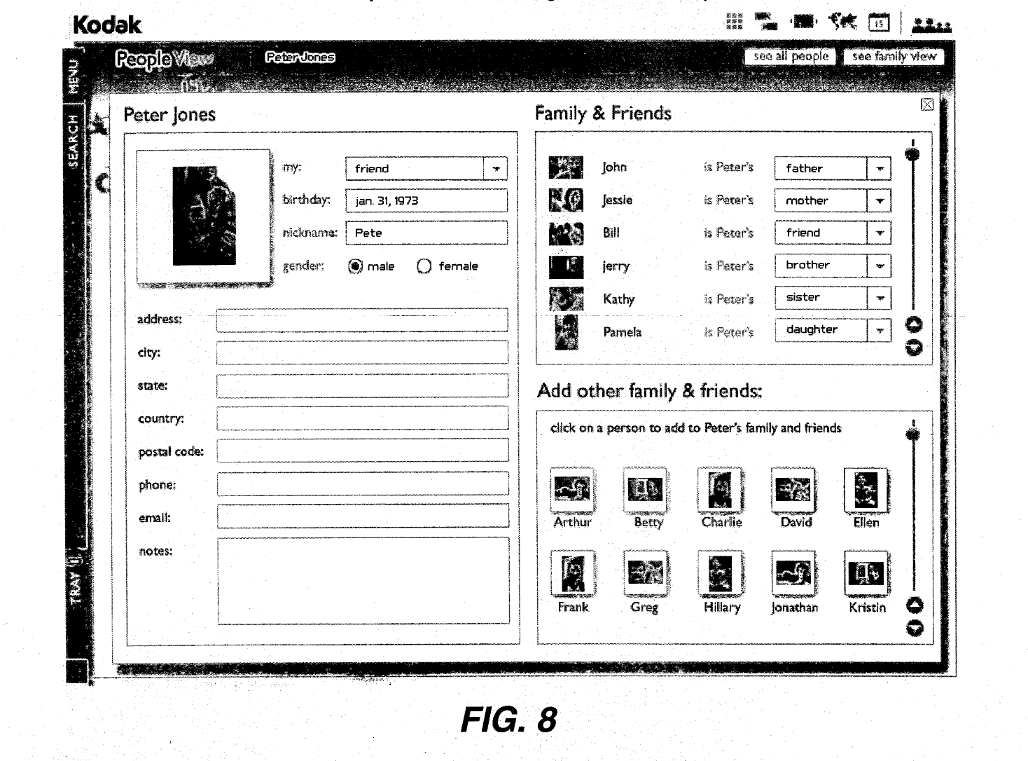

In step 204, the system 100 obtains information including but not necessarily limited to a description of the social relationships between one or more members of the audience and the people portrayed in the media asset. Referencing FIG. 6, the system 100 would attempt to obtain information pertaining to the social relationships between user 605 and people 601, 602 and 603. This information may be obtained in a variety of different ways. FIG. 8 illustrates a screen whereby personal information, including social relationships, may be entered into the system 100. Such information may be obtained in a variety of other ways, including, but not limited to, importing files created by programs for managing genealogical data, such as Family Tree Maker, or by obtaining data from social networking online sites, such as facebook.com. Social relationships include familial relationships such as parent, spouse, grandparent, etc., as well as other types of relationships including but not limited to former or current coworker, former or current classmate, and former or current member of a common society such as a fraternity, church, political party, or other interest group. Social relationships may also include relationships implied due to a person's position, such as a celebrity, political or military leader, etc.

In addition to social relationships explicitly specified by the user or imported from some other source, the system 100 may also infer additional social relationships implied by data available to the system 100. In a preferred embodiment, the system 100 may include multiple users, with social relationship data associated with each user. The system 100 may additionally infer additional social relationships by combining data from multiple users. For example, if user Karen has stated that Alice is her mother, Alice is a user of the system 100, and Alice has specified that Brenda is her mother, then the system 100 can infer that Brenda is Karen's grandmother.

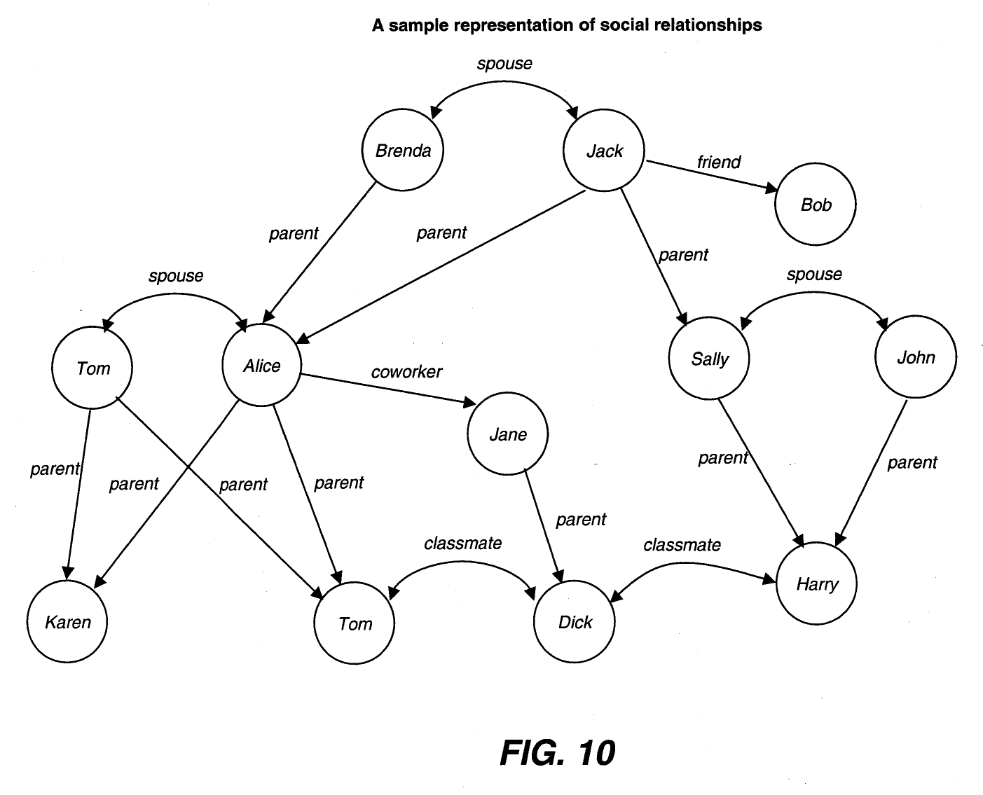

The type of relationships between people is stored in the data storage system 140. In a preferred embodiment, familial relationships may be stored in the canonical form of parent/child and spouse, with the system 100 inferring other types of familial relationships such as grandmother or aunt; alternatively, the type of relationship between each and every person may be directly stored in the database, reducing the need to infer relationships but at the cost of additional storage. Other types of social relationships, such as classmate, coworker or friend, are stored as direct links between the individuals. Expected social relationships other than familial relationships between two people may be additionally inferred between people given known relationships. For example, if for three school-age children Tom, Dick and Harry the data store 104 contains information indicating that Tom and Dick are classmates, and that Dick and Harry are classmates, then the system 100 may infer with some likelihood that Tom and Harry are also classmates, although this inference may not be true in all cases. FIG. 10 illustrates a simple subset of social relationships that might exist between a set of people.

In step 206, the system 100, given a particular audience, computes for each person portrayed in the asset, a measure of the person's expected social significance relative to the audience. In FIG. 6, the audience consists of one person 605 and the digital media asset 604 portrays three people. So the system 100 may be configured to compute three expected social significance, or ‘social relevance,’ scores: the social relevance of person 605 to person 601, the social relevance of person 605 to person 602, and the social relevance of person 605 to person 603.

Finally, in step 208, the system 100 computes an overall measure of the social significance of the digital media asset as a function of the expected social significance of each person recorded in the asset. With respect again to FIG. 6, the system 100 would compute a single score for the digital media asset 604 as a function over the social relevance scores for each person portrayed in the asset. This function may also include other metadata, including, but not limited to, the occasion, the current date, and the location. For example, the overall social significance of a particular digital media asset may be increased if it is being viewed on a day that is the birthday of one of the people portrayed in the asset.

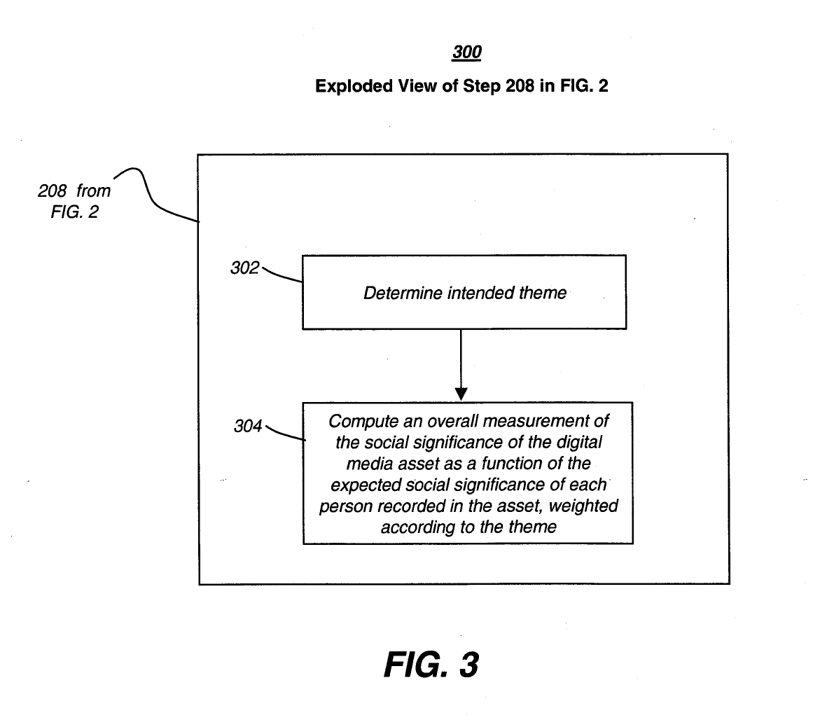

FIG. 3 illustrates an exploded view 300 of step 208 where the computation of the overall social significance of a particular asset includes consideration of the theme. The method of computing the overall social significance may be accomplished in a variety of manners; all such manners are included in the scope of this invention. For example, information pertaining to the circumstances of viewing, such as the occasion, may be used to adjust the computation of the individual social relevance scores before computing the overall social relevance score, or it may be used as a weighting factor in computing the overall social significance of the digital media asset.

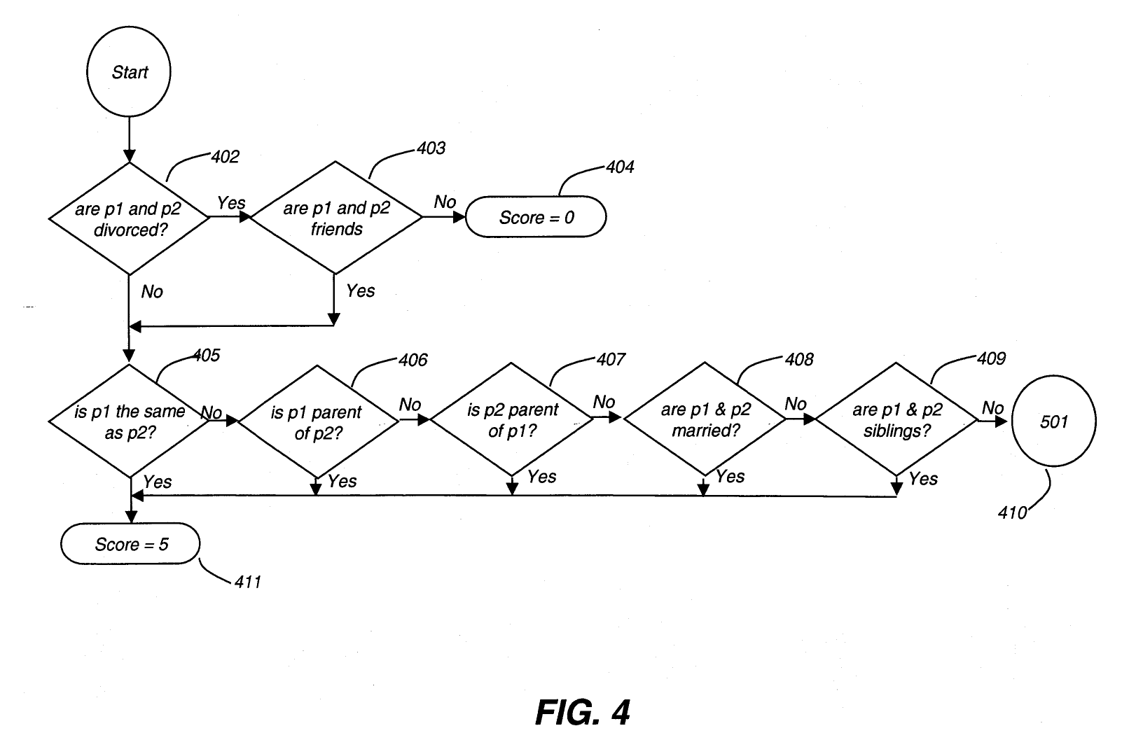

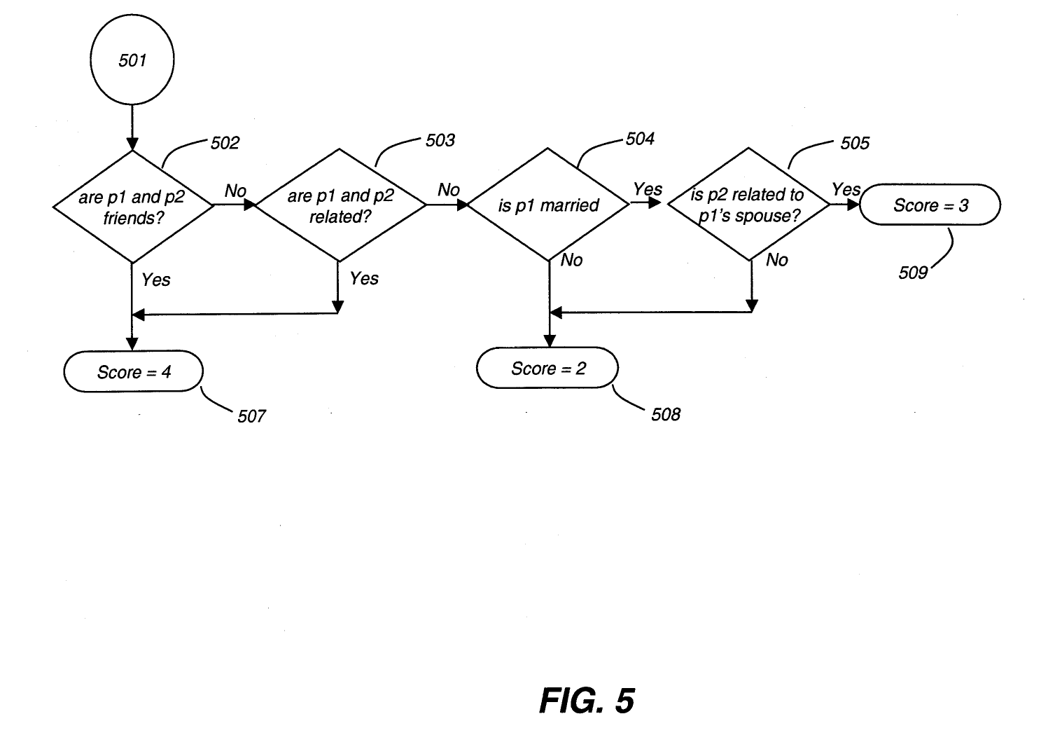

FIG. 4 and FIG. 5 illustrate one embodiment of a preferred embodiment for computing the social relevance score for two people p1 and p2, where p1 is assumed to be represented in a media asset, and p2 is assumed to be the audience viewing the media asset. This embodiment assigns a score between zero and five. In step 402, the embodiment considers whether or not p1 and p2 are divorced; if so, the embodiment further considers in step 403 if p1 and p2 are currently considered friends. If not, the social relevance score for these two people is set to zero in step 404. Otherwise, the embodiment checks in steps 405 through 408 whether or not p1 and p2 represent the same person, whether p1 is a parent of p2, whether p2 is a parent of p1, whether p1 and p2 are married, or whether p1 and p2 are siblings. If any of these conditions hold, then the social relevance score for p1 and p2 is set to five in step 411. Otherwise, the embodiment continues executing as shown in FIG. 5 beginning at step 501. The embodiment tests in step 502 whether or not p1 and p2 are considered friends; it tests in step 503 whether or not p1 and p2 are related, according to a definition of the term “related” described shortly. If either test holds, then the social relevance score for p1 and p2 is set to four in step 507. Otherwise, the embodiment tests in steps 504 and 505 whether or not p1 and p2 are related by marriage, specifically, whether or not p1 is married to a person to whom p2 is related. If so, then the social relevance score is set to three; otherwise it is set to two. A fully symmetric embodiment would also test whether p1 is related to a person to whom p2 is married.

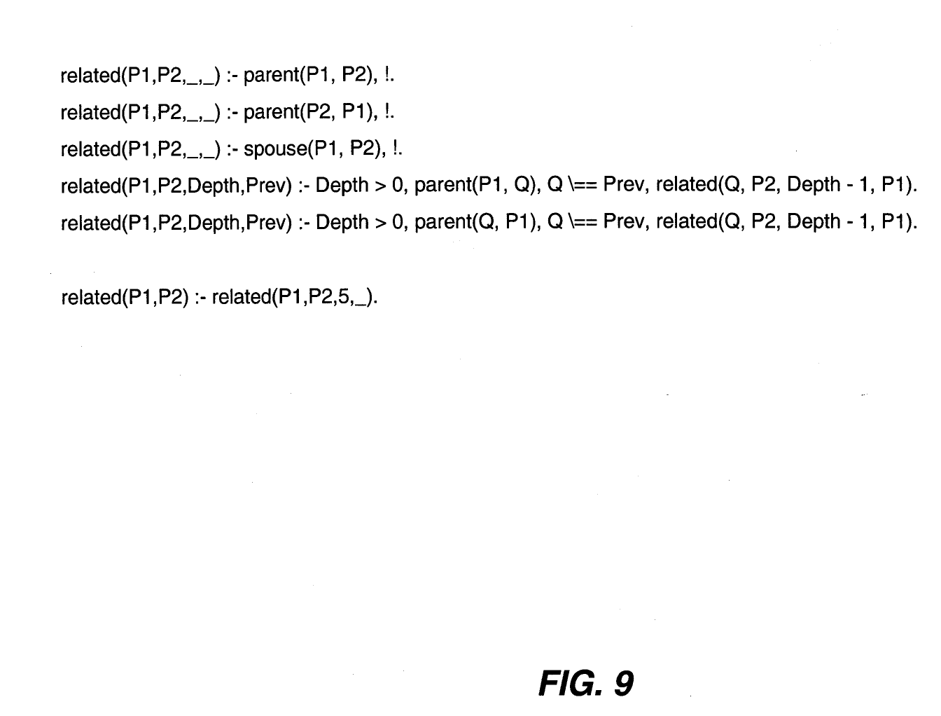

To determine whether or not two people are related, the embodiment illustrated in FIG. 9 may be employed. This embodiment, expressed using the logic programming language Prolog, defines two people p1 and p2 as being related by a series of rules that consider only the canonical relationships of parent/child and spouse. The embodiment also keeps track of how many relationships have been traversed as it searches for a chain of relationships between two people, and will not consider paths whose length is greater than a prescribed value. For ease of exposition, this embodiment was deliberately simplified. Those skilled in the art will readily appreciate that the embodiment may be made more efficient by a variety of techniques, including adding a mechanism to avoid redundant examination of relationships; the embodiment may also be expressed in other programming languages such as Lisp, Java or C#. Other preferred embodiments may employ different definitions of related, including definitions provided by the user, or associated with a group of users.

Referring again to FIG. 6, consider the case where person 601 is the spouse of viewer 605 (the audience), person 602 is known simply as a friend of the viewer 605, and person 603 is a child of the viewer 605. The embodiment of FIG. 4 and FIG. 5 would compute expected social relevance scores of persons 601, 602, and 603 relative to viewer 605 as five (‘yes’ at box 408), four (‘yes’ at box 502), and five (‘yes’ at box 407), respectively.

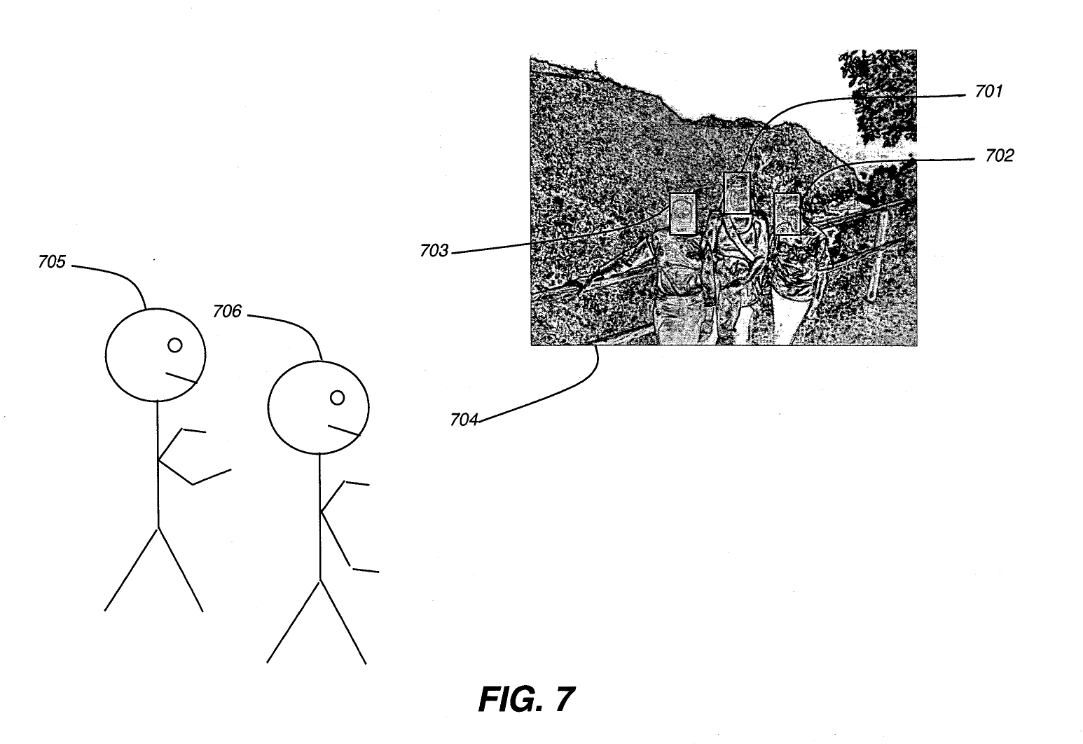

Building from the example just given with respect to FIG. 6, in FIG. 7 assume that viewer 705 is the same person as viewer 605, person 701 is the same as person 601, person 702 is the same as person 602, and person 703 is the same as person 603. Also assume that viewer 706 is a sibling of person 701, person 702 is a friend of viewer 706, and person 703 is a blood niece of viewer 706. Consequently, the embodiment of FIG. 4 and FIG. 5 would compute expected social relevance scores of persons 701, 702, and 703 relative to viewer 706 as five (‘yes’ at box 409), four (‘yes’ at box 502), and five (‘yes’ at box 503), respectively. Like the preceding example given with respect to FIG. 6, the expected social relevance scores of persons 701, 702, and 703 relative to viewer 705 would be calculated as five (‘yes’ at box 408), four (‘yes’ at box 502), and five (‘yes’ at box 407), respectively.

The individual expected social relevance scores associated with a media asset may be used to generate an overall measurement of the expected social significance of the digital media asset to the audience at step 208 in FIG. 2. The overall measurement may be generated simply by averaging all of the individual expected social relevance scores generated at step 206, which may or may not have been calculated according to the embodiment of FIGS. 4 and 5. With respect to the above-example from FIG. 6, the overall expected social relevance score for media asset 604 may be 4.67 (i.e., (5+4+5)/3). With respect to the above example from FIG. 7, the overall expected social relevance score for media asset 604 also may be 4.67, although it would be calculated differently (i.e., (5+4+5+5+4+5)/6).

One skilled in the art will appreciate, however, that more sophisticated embodiments may also be employed, including an embodiment that assigns different weights to people in the audience. For example, in one embodiment, one member of the audience could be designated as the primary person, and, consequently, the expected social relevance scores associated with this person could be weighted more greatly. Weights could be assigned to the other members of the audience based upon their expected social relevance score to the primary member. In another embodiment, particularly strong or weak expected social relevance scores between a person represented in the media asset and any member of the audience could dictate the overall measurement of expected social relevance of the media asset. For example, any of these combination functions could include a step whereby the overall measurement of the expected social relevance of the media asset is set to zero if the individual expected social relevance score between a person represented in the media asset and any member of the audience is zero.

Although the above examples provide simplistic illustrations of expected social relevance scores and calculations thereof, one skilled in the art will appreciate that the invention is not limited to any particular procedure used to calculate either individual expected social significance scores or overall measurements of expected social significance of media assets, so long as such procedures account at least for a social relationship between a member of an audience that is expected to view a media asset and a person represented in the asset. In this regard, any other secondary information may also be considered when calculating individual expected social significance or overall social significance. For example, access to an electronic calendar associated with an audience member may indicate that the audience member recently met with or will meet with a person represented in a media asset. This secondary information may be used to increase the expected social significance score associated with such a person.

In some embodiments of the present invention, the overall measurements of expected social significance calculated for multiple media assets may be combined into a measurement of expected social significance of the multiple media assets relative to the audience.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

### PARTS LIST

100 System
110 Data Processing System
120 Peripheral System
130 User Interface System
140 Data Storage System
200 Method
202 Step
204 Step
206 Step
208 Step
300 Exploded View of Step 208
302 Step
304 Step
400 Example
402 Step
403 Step
404 Step
405 Step
406 Step
407 Step
408 Step
409 Step
410 Step
411 Step
500 Process
501 Step
502 Step
503 Step
504 Step
505 Step
507 Step
508 Step
601 Person
602 Person
603 Person
604 Media asset
605 Viewer
701 Person
702 Person
703 Person
704 Media asset
705 Viewer
706 Viewer
p1 People
p2 People

What is claimed is:

1. A method implemented at least in part by a data processing system, the method for evaluating media assets in a set of media assets, and the method comprising the steps of:
obtaining information defining at least social relationships of an audience, wherein the social relationships include relationships between a member of the audience and someone recorded in at least one of the media assets;
for each media asset in the set of media assets:
identifying one or more people recorded in the digital media asset,
computing, for each person recorded in the digital media asset, the person's expected social significance relative to the audience based at least upon the social relationships, and
computing an overall measurement of the social significance of the digital media asset as a function of the expected social significance of each person recorded in the asset; and
storing the overall measurement for each digital media asset in a processor-accessible memory system.

2. The method of claim 1, wherein the audience comprises multiple persons.

3. The method of claim 2, wherein the computing of a person's expected social significance relative to the audience comprises computing an expected social significance relative to each person of the multiple persons in the audience.

4. The method of claim 3, wherein the computing of the overall measurement of the social significance of a media asset comprises combining the expected social significances computed for each person recorded in the digital media asset relative to each person of the multiple persons in the audience.

5. The method of claim 1, wherein the obtained information further defines at least a digital-media-asset presentation theme, and wherein the person's expected social significance relative to the audience is computed based at least upon the social relationships and the digital-media-asset presentation theme.

6. The method of claim 1, wherein the social relationships include familial relationships, friendships, or business relationships.

7. The method of claim 1, wherein the audience comprises a single person and multiple people are identified as being represented in a media asset.

8. The method of claim 7, wherein the computing of the overall measurement of the social significance of a media asset comprises combining the expected social significances computed for each person recorded in the digital media asset relative to the person in the audience.

9. The method of claim 1, wherein the set of media assets comprises multiple media assets, and the method further comprises the step of combining the overall measurements of social significance for the set of media assets into a measurement of social significance of the set of media assets.

10. A processor-accessible memory system storing instructions configured to cause a data processing system to implement a method for evaluating media assets in a set of media assets, wherein the instructions comprise:
instructions for obtaining information defining at least social relationships of an audience, wherein the social relationships include relationships between a member of the audience and someone recorded in at least one of the media assets;
instructions, for each media asset in the set of media assets, for:
identifying one or more people recorded in the digital media asset,
computing, for each person recorded in the digital media asset, the person's expected social significance relative to the audience based at least upon the social relationships, and
computing an overall measurement of the social significance of the digital media asset as a function of the expected social significance of each person recorded in the asset; and
instructions for storing the overall measurement for each digital media asset in a processor-accessible memory system.

11. The processor-accessible memory system of claim 10, wherein the audience comprises multiple persons.

12. The processor-accessible memory system of claim 11, wherein the computing of a person's expected social significance relative to the audience comprises computing an expected social significance relative to each person of the multiple persons in the audience.

13. The processor-accessible memory system of claim 12, wherein the computing of the overall measurement of the social significance of a media asset comprises combining the expected social significances computed for each person recorded in the digital media asset relative to each person of the multiple persons in the audience.

14. The processor-accessible memory system of claim 10, wherein the obtained information further defines at least a digital-media-asset presentation theme, and wherein the person's expected social significance relative to the audience is computed based at least upon the social relationships and the digital-media-asset presentation theme.

15. A system comprising:
a data processing system; and
a memory system communicatively connected to the data processing system and storing instructions configured to cause the data processing system to implement a method for evaluating media assets in a set of media assets, wherein the instructions comprise:
instructions for obtaining information defining at least social relationships of an audience, wherein the social relationships include relationships between a member of the audience and someone recorded in at least one of the media assets;
instructions, for each media asset in the set of media assets, for:
identifying one or more people recorded in the digital media asset,
computing, for each person recorded in the digital media asset, the person's expected social significance relative to the audience based at least upon the social relationships, and
computing an overall measurement of the social significance of the digital media asset as a function of the expected social significance of each person recorded in the asset; and
instructions for storing the overall measurement for each digital media asset in a processor-accessible memory system.

16. The system of claim 15, wherein the audience comprises multiple persons.

17. The system of claim 16, wherein the computing of a person's expected social significance relative to the audience comprises computing an expected social significance relative to each person of the multiple persons in the audience.

18. The system of claim 17, wherein the computing of the overall measurement of the social significance of a media asset comprises combining the expected social significances computed for each person recorded in the digital media asset relative to each person of the multiple persons in the audience.

19. The system of claim 15, wherein the obtained information further defines at least a digital-media-asset presentation theme, and wherein the person's expected social significance relative to the audience is computed based at least upon the social relationships and the digital-media-asset presentation theme.
